(19) United States
(12) Patent Application Publication
(10) Pub. No.: US 2023/0302314 A1
(43) Pub. Date: Sep. 28, 2023

(54) HYBRID WATER MIST FOR FIRE SUPPRESSION

(71) Applicant: Tyco Fire Products LP, Cranston, RI (US)

(72) Inventor: Sean S. Troutt, Stephenson, MI (US)

(73) Assignee: Tyco Fire Products LP, Cranston, RI (US)

(21) Appl. No.: 18/187,442

(22) Filed: Mar. 21, 2023

Related U.S. Application Data
(60) Provisional application No. 63/323,619, filed on Mar. 25, 2022.

(51) Int. Cl. A62C 3/16; A62C 31/02; A62C 3/07; A62C 5/00

(52) U.S. Cl. CPC A62C 3/16; A62C 31/02; A62C 3/07; A62C 5/008; A62C 5/002

(57) ABSTRACT

A fire suppression system for mitigating a thermal runaway event. The system comprising a battery pack having a housing defining a volume, a battery module arranged within the housing, and a plurality of battery cells arranged within the battery module, where the plurality of battery cells are configured to provide an electrical output. The system also comprising a suppression system coupled with the battery pack, the suppression system comprising a nozzle configured to receive a gaseous fluid and a liquid fluid, where the nozzle is configured to deliver a mist suppressant including the gaseous fluid and the liquid fluid to the battery pack, such that the gaseous fluid entrains the liquid fluid to mitigate the thermal runaway event.

### CROSS-REFERENCE TO RELATED PATENT APPLICATION

This application claims the benefit of and priority to U.S. Provisional Application No. 63/323,619, filed Mar. 25, 2022, the entire disclosure of which is incorporated by reference herein.

### BACKGROUND

The present disclosure relates generally to fire suppression systems. More specifically, the present disclosure relates to fire suppression systems for batteries. Modern battery technologies, such as lithium-ion batteries, are desirable for use in many energy storage applications due to their high energy density. However, the materials used in such batteries can be quite flammable and can produce flammable gases (e.g., when overheating). Once the batteries ignite, the resultant fires can be difficult to suppress due to their high temperatures, and the fires can travel quickly between adjacent battery cells. The cells of the batteries are often contained within a sealed housing, making it difficult for an external source of fire suppressant to reach the cells.

### SUMMARY

At least one embodiment relates to fire suppression system for mitigating a thermal runaway event. The system includes a battery pack having a housing defining a volume, a battery module arranged within the housing, and a plurality of battery cells arranged within the battery module, where the plurality of battery cells are configured to provide an electrical output. The system also includes a suppression system coupled with the battery pack, the suppression system comprising a nozzle configured to receive a gaseous fluid and a liquid fluid, where the nozzle is configured to deliver a mist suppressant including the gaseous fluid and the liquid fluid to the battery pack, such that the gaseous fluid entrains the liquid fluid to mitigate the thermal runaway event.

Another embodiment relates to a method of mitigating a thermal runaway event within a battery pack. The method comprising receiving, at a first inlet of a nozzle, a gaseous fluid, and receiving, at a second inlet of the nozzle, a liquid fluid. The method also includes generating a mist suppressant, the mist suppressant comprising the gaseous fluid and the liquid fluid, such that the gaseous fluid entrains the liquid fluid, and delivering, via an outlet of the nozzle, the mist suppressant to the battery pack to mitigate the thermal runaway event.

Another embodiment relates to a container system for mitigating a thermal runaway event. The container system includes a container defining an inner volume, and a battery pack arranged within the container. The battery pack includes a housing defining a volume, a battery module arranged within the housing, and a plurality of battery cells arranged within the battery module, where the plurality of battery cells are configured to provide an electrical output. The container system also includes a suppression system coupled with the container, the suppression system comprising a nozzle configured to receive a gaseous fluid and a liquid fluid, where the nozzle is configured to deliver a mist suppressant including the gaseous fluid and the liquid fluid to the container, such that the gaseous fluid entrains the liquid fluid to mitigate the thermal runaway event

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a battery system, according to an exemplary embodiment.

FIG. 2 is a block diagram of a control system for the battery system of FIG. 1, according to an exemplary embodiment.

FIG. 3 is a left side view of a vehicle utilizing the battery system of FIG. 1, according to an exemplary embodiment.

FIG. 4 is a perspective view of a containerized energy storage system including the battery system of FIG. 1, according to an exemplary embodiment.

FIG. 5 is a cross-sectional view of the nozzle of FIG. 1, according to an exemplary embodiment.

FIG. 6 is a cross-section view of the nozzle of FIG. 1 showing the nozzle generating a mist, according to an exemplary embodiment.

FIG. 7 is a schematic diagram of the battery system of FIG. 1 showing operation of the suppression system of FIG. 1 to mitigate thermal runaway, according to an exemplary embodiment.

FIG. 8 is a schematic diagram of the battery system of FIG. 1 showing operation of the suppression system of FIG. 1 to mitigate thermal runaway, according to another exemplary embodiment.

FIG. 9 is a schematic diagram of the battery system of FIG. 1 showing operation of the suppression system of FIG. 1 to mitigate thermal runaway, according to another exemplary embodiment.

FIG. 10 is a schematic diagram of the battery system of FIG. 1 showing operation of the suppression system of FIG. 1 to mitigate thermal runaway, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a battery system is configured to provide a fire suppressant or agent to components of a battery pack in order to prevent, eliminate, and/or mitigate a failure or thermal runaway event is shown, according to exemplary embodiments. In an exemplary embodiment, the battery system includes a battery module which includes a number of battery cells configured to provide electrical output. The battery system may include a cooling system and a suppression system. The suppression system may include a mist generating device (e.g., a nozzle, a venturi valve, etc.). The mist generating device may be configured to receive a gaseous fluid agent and a liquid fluid agent and generate a mist which includes the gaseous fluid agent and the liquid fluid agent. The mist generating device may be configured to deliver (e.g., provide, distribute, spray, cover, etc.) the gaseous fluid agent and the liquid fluid agent to the number of battery cells and the various passages formed by the arrangement of the number of the battery cells and the various modular housings disposed within the battery pack which house various arrangements of the number of batteries. According to an exemplary embodiment, the gaseous fluid agent entrains the liquid fluid agent for delivery to the number of battery cells. According to another exemplary embodiment, the liquid fluid agent remains within the battery pack for a period of time longer than the gaseous fluid agent, such that the liquid fluid agent acts to prevent, eliminate, and/or mitigate the failure or thermal runaway event longer than the gaseous fluid agent.

System Overview

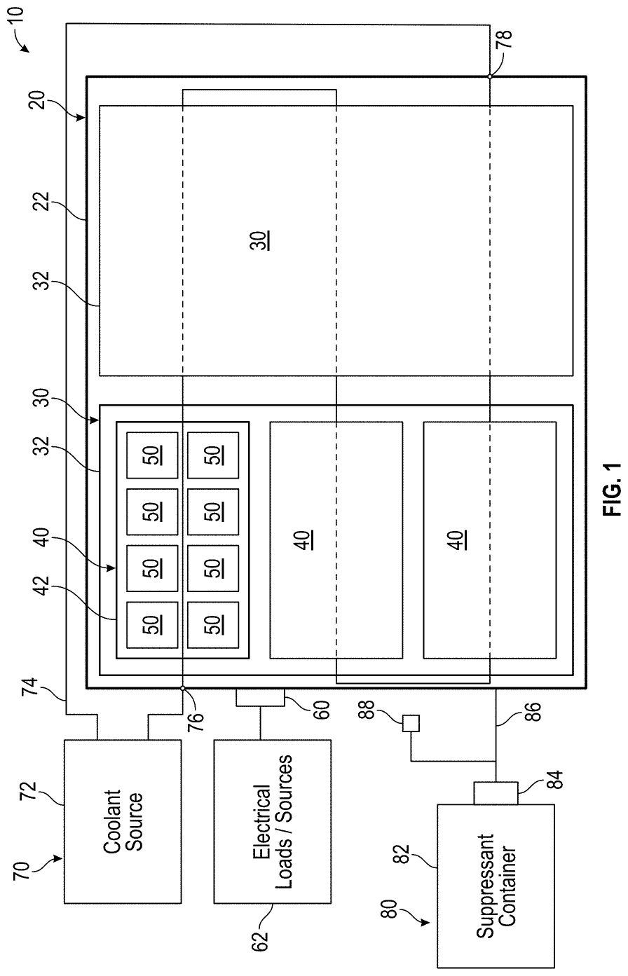

Referring to FIG. 1, a power system or battery system, shown as system 10, includes an energy storage device, energy storage assembly, battery assembly, power source, or electrical energy source, shown as battery pack 20, according to an exemplary embodiment. The battery pack 20 is configured to store energy (e.g., chemically) and later discharge the stored energy as electrical energy to power one or more electrical loads (e.g., electric motors, resistive elements, lights, speakers, etc.). In some embodiments, the battery pack 20 is rechargeable using electrical energy (e.g., from an electrical grid, from a fuel cell, from a solar panel, from an electrical motor being driven as a generator, etc.).

The battery pack 20 includes a shell or housing, shown as pack housing 22, that defines a volume containing components of the battery pack 20 (e.g., the subpacks 30). The pack housing 22 may seal the components of the battery pack 20 from the surrounding environment (e.g., limiting or preventing ingress of water or dust). The pack housing 22 may define one or more ports to facilitate transfer of electrical energy, coolant, fire suppressant, or other material into or out of the battery pack 20.

The battery pack 20 includes a series of battery portions or sections, shown as subpacks 30. By way of example, the battery pack 20 may include four subpacks 30. In other embodiments, the battery pack 20 includes more or fewer subpacks 30. Each subpack 30 is configured to store a portion of the stored energy of the battery pack 20. Each subpack 30 includes a housing 32 containing components of the subpack 30 (e.g., the battery modules 40).

Each subpack 30 includes a series of battery portions or sections, shown as battery modules 40. By way of example, each subpack 30 may include eight battery modules 40. In other embodiments, each subpack 30 includes more or fewer battery modules 40. Each battery module 40 is configured to store a portion of the stored energy of the corresponding subpack 30. Each battery module 40 includes a housing 42 containing components of the battery module 40 (e.g., the battery cells 50).

Each battery module 40 includes a series of battery portions or sections, shown as battery cells 50. By way of example, each battery module 40 may include hundreds of battery cells 50. In other embodiments, each battery module 40 includes more or fewer battery cells 50. Each battery cell 50 is configured to store a portion of the energy stored by the corresponding battery module 40.

In some embodiments, the battery cells 50 are lithium-ion (i.e., Li-ion) battery cells. Each battery cell 50 may be configured to receive electrical energy, store the received energy chemically, and release the stored electrical energy. As shown in FIG. 1, the battery cells 50 are arranged in rows adjacent one another within the battery module 40, reducing empty space within the battery module 40 and reducing the overall size of the battery pack 20. The battery cells 50 may be cylindrical cells, prismatic cells, pouch cells, or another form factor of battery cells.

The battery cells 50 may be electrically coupled to one another within the battery pack 20. By way of example, in one arrangement (a) the battery cells 50 within each battery module 40 are electrically coupled to one another, (b) the battery modules 40 within each subpack 30 are electrically coupled to one another, and (c) the subpacks 30 are electrically coupled to one another. The collective arrangement of battery cells 50, battery modules 40, and subpacks 30 is electrically coupled to a connector or port, shown as electrical port 60. The electrical port 60 electrically couples the battery cells 50 to one or more electrical sources and/or loads, shown as electrical loads/sources 62. The battery cells 50 may be discharged through the electrical port 60 to power the electrical loads/sources 62. The battery cells 50 may receive electrical energy through the electrical port 60 to charge the battery cells 50.

The battery cells 50, the battery modules 40, and the subpacks 30 may be arranged in series/parallel to control the output voltage of the battery pack 20 at the electrical port 60 and the capacity of the battery pack 20 at that output voltage. Battery cells 50 may be arranged in series with one another to increase an output voltage of the battery pack 20. Battery cells 50 may be arranged in parallel with one another to increase the capacity (e.g., measured in amp-hours) of the battery pack 20. By way of example, the battery modules 40 within each subpack 30 may be connected to one another in series, forming a string. The subpacks 30 may be connected to one another in parallel, such that the strings are connected in parallel.

In other embodiments, the battery pack 20 is otherwise arranged. By way of example, the battery pack 20 may include more or fewer battery cells 50, battery modules 40, and/or subpacks 30. By way of another example, the battery cells 50, battery modules 40, and/or subpacks 30 may be arranged in rows, columns, helical patterns, or otherwise positioned within the pack housing 22. In some embodiments, the subpacks 30 are omitted, and the battery modules 40 are positioned directly within the battery pack 20.

In some embodiments, the system 10 includes a cooling subsystem, shown as cooling system 70. The cooling system 70 includes a coolant source 72 that is configured to supply a flow of coolant to one or more conduits, shown as cooling channels 74. The coolant source 72 may include pumps, reservoirs, valves, and/or other components that facilitate handling the coolant. The coolant source 72 may also include one or more radiators or heat exchangers that facilitate discharging thermal energy from the coolant (e.g., to the surrounding atmosphere).

The cooling channels 74 pass into the pack housing 22 at an inlet 76 and exit the pack housing 22 at an outlet 78. The cooling channels 74 pass through the housings 32 of the subpacks 30 and the housings 42 of the battery modules 40 and pass adjacent (e.g., in contact with) the battery cells 50. In some embodiments, at least a portion of the cooling channels 74 is contained within and/or pass along the walls of the pack housing 22, the housings 32, and/or housings 42. The cooling channels 74 facilitate conduction between the coolant and the battery cells 50, such that thermal energy generated by the battery cells 50 (e.g., when charging or discharging electrical energy) is transferred to the coolant. The flow of coolant then transfers the thermal energy back to the coolant source 72 to be discharged. Accordingly, the cooling system 70 facilitates maintaining a consistent, low operating temperature of the battery pack 20.

Referring to FIG. 1, the system 10 further includes a fire suppression system, fire prevention system, or fire mitigation system, shown as suppression system 80. The suppression system 80 is configured to address fires within the battery pack 20 by supplying a fire suppressant. The suppressant may suppress active fires (e.g., preventing the fire from accessing oxygen). The suppressant may also cool the battery cells 50, preventing later ignition or reignition of the battery cells. The suppression system 80 may advantageously prevent, address, or otherwise mitigate thermal runaway of the battery cells 50.

The suppression system 80 includes a container of suppressant (e.g., a tank, a vessel, a cartridge, a reservoir, etc.) or fire suppressant source, shown as suppressant container 82. The suppressant may be held at an elevated pressure to facilitate dispensing the suppressant. The suppressant may include a gas (e.g., an inert gas, nitrogen, etc.), a liquid suppressant (e.g., water), a gel suppressant, a dry chemical suppressant, another type of suppressant, or combinations thereof.

The suppression system 80 further includes an actuator, shown as activator 84, that is configured to initiate a transfer (e.g., a flow) of fire suppressant from the suppressant container 82 to the battery pack 20. By way of example, the activator 84 may include a valve or seal puncture actuator that selectively permits suppressant to flow out of the suppressant container 82. By way of another example, the activator 84 may include a pump that is configured to impel the flow of suppressant.

The suppression system 80 further includes one or more conduits (e.g., pipes, hoses, tubes, etc.), shown as distribution network 86, that is configured to transfer suppressant from the suppressant container 82 to the battery pack 20. The distribution network 86 may transfer the suppressant to the interior of the battery pack 20 (e.g., inside the pack housing 22, inside the housing 32, inside the housing 42, etc.). Additionally or alternatively, the distribution network 86 may transfer the suppressant to the exterior of the battery pack 20. By way of example, the distribution network 86 may provide the suppressant to an outlet, shown as nozzle 88, that is positioned to direct suppressant to the exterior of the pack housing 22.

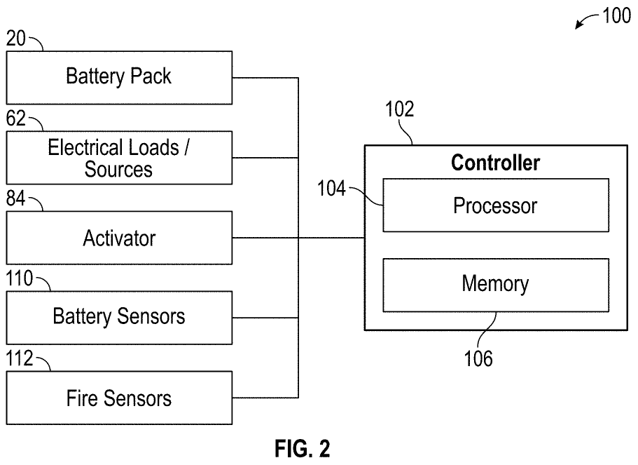

Referring to FIG. 2, a control system 100 of the system 10 is shown according to an exemplary embodiment. The control system 100 includes a processing circuit, shown as controller 102, including a processor 104 and a memory 106. The processor 104 may execute one or more instructions stored within the memory 106 to perform any of the functions described herein.

As shown, the controller 102 is operatively coupled to the battery pack 20, the electrical loads/sources 62, and the activator 84. The controller 102 may be configured to control operation of the battery pack 20 (e.g., as a battery management system), the electrical loads/sources 62, the suppression system 80, or any other component of the system 10. By way of example, the controller 102 may control charging and/or discharging of the battery pack 20. By way of another example, the controller 102 may control activation of the suppression system 80 to address one or more fires.

The control system 100 further includes one or more sensors, shown as battery sensors 110, operatively coupled to the controller 102. The battery sensors 110 may be configured to provide sensor data measuring one or more parameters related to the performance of the battery pack 20. By way of example, the battery sensors 110 may measure a current, voltage, and/or charge level within the battery pack 20. The battery sensors 110 may measure performance at the battery cell 50 level, the battery module 40 level, the subpack 30 level, and/or the battery pack 20 level. In some embodiments, the controller 102 is configured to use information from the battery sensors 110 to detect or predict a thermal event (e.g., a fire) associated with the battery pack 20. By way of example, the controller 102 may identify a change in measured current, voltage, or charge level that is indicative of a fire.

The control system 100 further includes one or more sensors, shown as thermal event sensors 112, configured to detect or predict a thermal event (e.g., a fire) associated with the battery pack 20. By way of example, the thermal event sensors 112 may include temperature sensors configured to detect an increase in temperature (e.g., of one of the battery cells 50) associated with a fire or a prediction of a fire. By way of another example, the thermal event sensors 112 may include an aspirating smoke detector that is configured to identify the presence of smoke or a gas that is produced (e.g., offgassed) when the battery cells 50 are above the standard operating temperature range. By way of another example, the thermal event sensors 112 may include an optical sensor that detects light produced by a fire.

In response to detection or prediction of a fire, the controller 102 may activate the suppression system 80 to address (e.g., prevent or suppress) the fire. By way of example, the controller 102 may actuate the activator 84 to direct suppressant to the battery pack 20. This suppressant may enter and/or surround the battery pack 20, addressing the fire.

Although a single controller 102 is shown in FIG. 2, it should be understood that the functionality of the controller 102 may be distributed across two or more separate controllers in communication with one another. By way of example, a first controller (e.g., a battery controller) may be dedicated for the battery management (e.g., controlling power usage from the battery cells 50 and charging of the battery cells 50). A second controller (e.g., a fire system controller) may be dedicated for management of the fire suppression system 80 (e.g., control over the activator 84 and the thermal event sensors 112). The two controllers would have the ability to communicate with each other such that when the fire system controller detects a fire, the fire system controller provides a signal to the battery controller. This signal commands the battery controller to disconnect or shut down usage of the affected batteries (e.g., battery packs 20, subpacks 30, battery modules 40, and/or battery cells 50) prior to discharging the fire suppression system 80.

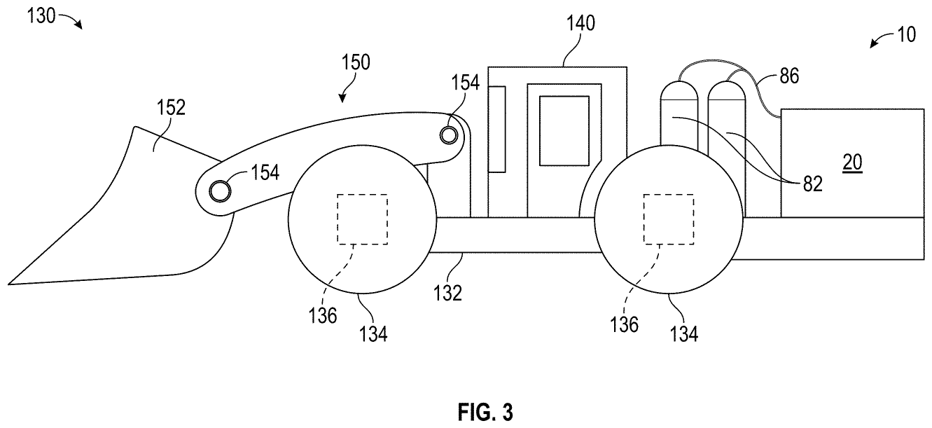

Referring to FIG. 3, a vehicle 130 is equipped with the battery system 10, according to an exemplary embodiment. As shown, the vehicle 130 is configured as a mining vehicle. Specifically, the vehicle 130 is configured as a front end loader. In other embodiments, the vehicle 130 is configured as another type of vehicle, such as a forestry vehicle, a passenger vehicle (e.g., a bus), a boat, or yet another type of vehicle.

The vehicle 130 includes a frame, shown as chassis 132, that is coupled to and supports a battery pack 20 and a pair of suppressant containers 82. The vehicle 130 includes a series of tractive elements (e.g., wheel and tire assemblies), shown as tractive elements 134, that are rotatably coupled to the chassis 132. The tractive elements 134 engage a support surface (e.g., the ground) to support the vehicle 130. The tractive elements 134 are coupled to a series of electric actuators or prime movers, shown as drive motors 136. The drive motors 136 are configured to drive the tractive elements 134 to propel the vehicle 130. In some embodiments, the drive motors 136 are electrically coupled to the battery pack 20. The drive motors 136 may consume electrical energy from the battery pack 20 (e.g., when propelling the vehicle 130) and/or provide electrical energy to charge the battery pack 20 (e.g., when performing regenerative braking).

The vehicle 130 further includes an operator compartment or cabin, shown as cab 140, that is coupled to the chassis 132. The cab 140 may be configured to contain one or more operators of the vehicle 130. The cab 140 may include one or more user interface elements (e.g., steering wheels, pedals, shifters, switches, knobs, dials, screens, indicators, etc.) that facilitate operation of the vehicle 130 by an operator.

The vehicle 130 further includes an implement assembly 150 coupled to the chassis 132. As shown, the implement assembly 150 includes an implement, shown as bucket 152. The implement assembly 150 further includes one or more actuators (e.g., electric motors, electric linear actuators, etc.), shown as implement actuators 154, that are configured to cause movement of the bucket 152 relative to the chassis 132. The implement actuators 154 may be electrically coupled to the battery pack 20. The implement actuators 154 may consume electrical energy from the battery pack 20 (e.g., when moving the bucket 152) and/or provide electrical energy to charge the battery pack 20 (e.g., when slowing the movement of the bucket 152).

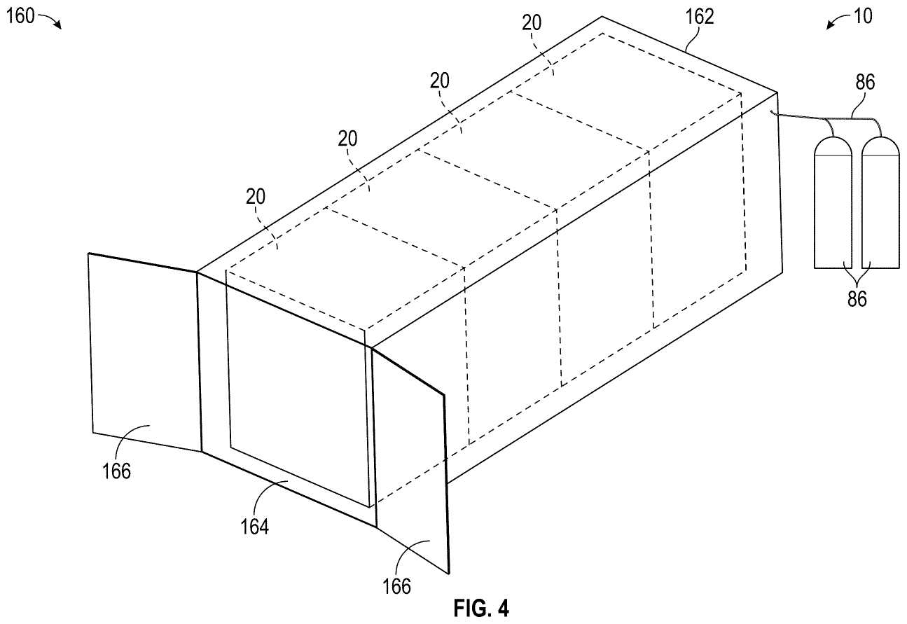

Referring to FIG. 4, a containerized energy storage system, shown as container system 160, is equipped with the battery system 10, according to an exemplary embodiment. In some embodiments, the container system 160 is configured to store energy to power one or more external electrical loads. The container system 160 may be portable (e.g., using a crane, using a container ship, using a semi truck, etc.).

As shown, the container system 160 includes a container, shown as shipping container 162, defining an internal volume 164. The internal volume 164 is selectively accessible from outside of the shipping container 162 through one or more doors 166. The internal volume 164 contains a series of battery packs 20 coupled to the shipping container 162. The battery packs 20 may be electrically coupled to one another, providing a large energy storage capacity.

Hybrid Water Mist Suppressant

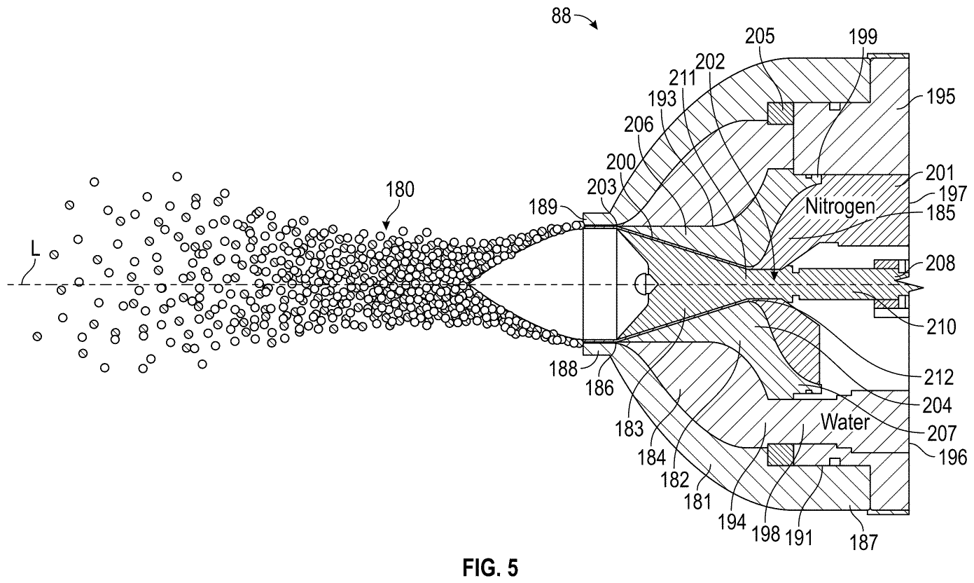

Referring to FIGS. 5-10, the suppression system 80 may be a hybrid water mist suppression system, according to various embodiments. Hybrid water mist suppression systems may combine water/liquid and gaseous fire suppression agents for application to a hazard via one or more nozzles and/or valves. As described in greater detail below, a high velocity discharge of a gaseous fluid agent (e.g., nitrogen, carbon dioxide, argon, oxygen, another gas, or some combination thereof) may be used to generate and entrain a water/liquid mist (e.g., a liquid fluid agent, water, water additive, some other liquid, or some combination thereof) in the discharge. The gaseous fluid agent may rapidly inert (e.g., depleting oxygen levels used as a fuel for thermal runaway such that thermal runaway is abated or eliminated) a hazard space and the liquid fluid agent may provide extended cooling and inerting of the space. For example, the gaseous agent may inert the space and abate thermal runaway (e.g., prevent fire) much faster than a water mist would. However, a limiting factor may be the “hold time” of the gaseous fluid agent (e.g., the amount of time that the gaseous agent can keep the space inerted). In this case, the liquid fluid agent is able to also inert the space as the liquid fluid agent turns to vapor due to the heat of the thermal runaway event, and further provide extended cooling as the water droplets evaporate and increase humidity and/or are converted to steam. The various surfaces and volumes afflicted by the thermal runaway event may get damp and/or saturated with the liquid fluid agent to the point where the thermal runaway event is eliminated. Such an evaporation process may take a longer time for smaller thermal runaway events (e.g., low heat release rates) and occur faster with larger thermal runaway events (e.g., higher heat release rates). In some embodiments, the concentration of gaseous fluid agent discharged by the nozzle 88 is comparatively greater than the concentration of the liquid fluid agent. In other embodiments, the concentration of the gaseous fluid agent discharged by the nozzle 88 is less than the concentration of the liquid fluid agent. In other embodiments still, the concentration of the gaseous fluid agent is configured to be high enough to perform the various functions descried herein in regards to suppression of a thermal runaway event.

In some embodiments, the mist discharge of the suppression system 80 includes droplets. The extremely small droplet size generated by this type of discharge may allow the mist discharge to penetrate all areas of the battery system, including those confined and partially inaccessible from direct agent application. This technique may provide rapid agent dispersion over a large area and help to suppress multiple hazard types including thermal runaways and failures involving battery applications. In some embodiments, the droplet size produced by the nozzle 88 is smaller than the droplet size produced by typical watermist systems. In this sense, the combination of the high velocity gaseous liquid agent stream and the small droplet size enables the water mist to be distributed everywhere, or a significant portion of, a volume of space afflicted by a thermal runaway event. This may include the inside of battery module enclosures (e.g., the battery module enclosures are ventilated and not sealed). However, in some embodiments where a sealed enclosure bursts open due to the pressure generated inside as a result of a battery cell in thermal runaway, then the watermist would be able to be distributed to the volume of that ruptured enclosure once the internal pressure is released.

Referring to FIG. 5, the suppression system 80 is shown directing a suppressant 180 (e.g., a discharge, a mist discharge, an inert fluid, etc.), according to an exemplary embodiment. As shown, the suppression system 80 includes the nozzle 88 (e.g., a mist generating device, a valve, etc.) positioned to direct the suppressant 80 to the battery pack 20. In some embodiments, the nozzle 88 includes a cover 181, a funnel 182, a plug 183, a first fluid passage 184, a second fluid passage 185, an outlet 186, and a base 195. In some embodiments, the nozzle 88 is a venturi nozzle.

In some embodiments, the base 195 is a generally circular member including a first inlet passage 196 fluidly coupled to the first fluid passage 184 and a second inlet passage 197 fluidly coupled to the second fluid passage 185. The first inlet passage 196 and the second inlet passage 197 may be adapted to receive, respectively, a liquid fluid agent and a gaseous fluid agent from their respective fluid supply sources (not shown).

In some embodiments, the cover 181 is generally dome-shaped, having a first end 187 of larger diameter than a second end 188. Projecting axially from the second end 188 of the cover 181 is an annular lip 189. The lip 189 has an internal surface which defines a chamber or bore of substantially constant diameter. The cover 181 has a first section adjacent the first end 187 which has a first inner surface 191 of substantially constant diameter. A second section of the cover 181 extending between the first section and the lip 189 has a second inner surface 192. The diameter of the second section reduces in the direction of the second end 188. For example, the second inner surface 192 may have a smooth inwardly curving profile as it progresses towards the second end 188, with no steps or angles present on the inner surface 192. The second inner surface 192 of the cover 181 and the outer surface 193 of the funnel 182 define the first fluid passage 184 having an inlet 194 and an outlet 186. The inlet 194 of the first fluid passage 184 is in fluid communication with the first inlet passage 196 of the base 195 and first fluid passage 198 of the funnel 182. Due to the contours of the second inner surface 192 of the cover 181 and outer surface 193 of the funnel, the first fluid passage 184 has a divergent-convergent internal geometry. In other words, the cross sectional area of a portion of the first fluid passage 184 intermediate the inlet 194 and outlet 186 is greater than the cross sectional area at either the inlet 194 or outlet 186. The cross sectional area of the first fluid passage 184 progressively reduces following the intermediate portion.

In some embodiments, the funnel 182 is engaged with the base 195 so that the base 195 and the funnel 182 are concentrically disposed about a longitudinal axis L. The funnel 182 has a first end 199, a second end 200, and a bore 202 extending longitudinally through the funnel 182 from the first end 199 to the second end 200 to generally define the second fluid passage 185. The bore 202 defines an inlet 201 at the first end 199, an outlet 203 at the second end 200, and a throat portion 204 intermediate the inlet 201 and the outlet 203. At the inlet 201 the bore 202 defines a diameter D1, at the throat portion 204 the bore 202 defines a diameter D2, and at the outlet 203 the bore 202 defines a diameter D3. The diameter D1 at the inlet 201 is greater than the diameter D2 or D3, whilst the diameter D2 at the throat portion 204 is less than the diameters D1 and D3. As a result, the bore 202 narrows from its widest point at the inlet 201 to a narrow diameter at the throat portion 204 before widening again until it reaches the outlet 203. In some embodiments, the funnel 182 is formed as a single piece member having a radially extending flange portion 205 and an axially projecting body portion 206. The body portion 206 has an outer surface 193. An annular lip portion 207 extends rearwards from the flange portion 205 defining the first fluid passage 198.

In some embodiments, the plug 183 is an elongate member having a first end 208 and a second end 209. The plug 183 has a first generally cylindrical portion 210 and a second conical portion 211. The conical portion 211 may be in the shape of an inverted cone, with the narrowest point of the cone adjacent the cylindrical portion 210 and the widest point of the cone at the second end 209 of the plug 183.

In some embodiments, the inlet 201 of the funnel bore 202 acts as the inlet of the second fluid passage 185. The second fluid passage 185 further includes a throat passage portion 212 adjacent the throat portion 204 of the bore 202 of the funnel 182, and an outlet 203 adjacent the respective second ends 200, 209, of the funnel 182 and plug 183. As a result of the previously mentioned variations in the diameter of the bore 202 and the outward taper of the conical portion 211 of the plug 183, the second fluid passage 185 has a convergent-divergent internal geometry. In other words, the cross-sectional area of the throat passage portion 212 of the second fluid passage 185 is considerably smaller than that of the inlet 201 and the outlet 203. The cross sectional area of the second fluid passage 185 at the outlet 203 may be greater than that at the throat passage portion 212, but less than that at the inlet 201.

While depicted in a particular embodiment in FIG. 5 it should be appreciated that the nozzle 88 may be constructed in any number of configurations, arrangements, and geometries that ultimately provide a discharge of a gaseous fluid agent capable of entraining a liquid fluid agent.

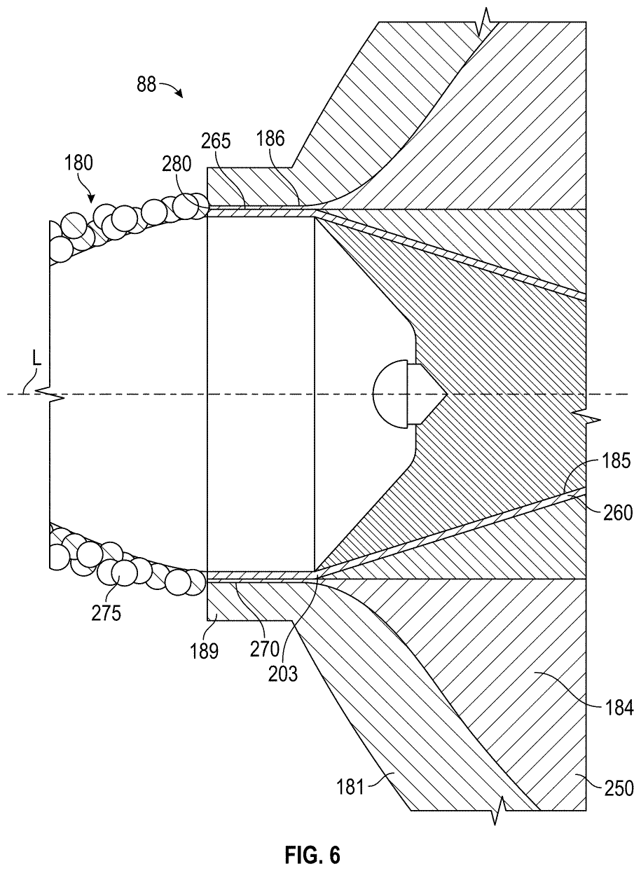

Referring to FIG. 6, the nozzle 88 is shown discharging a gaseous fluid agent that entrains a liquid fluid agent to form a mist discharge for the suppressant 180, according to some embodiments. The outlet 186 receives a first fluid 250 from the first fluid passage 184 and the outlet 203 receives a second fluid 260 from the second fluid passage 185. The first fluid 250 is the liquid fluid agent. For example, the liquid fluid agent may be water. As suggested above in regards to FIG. 5, the first fluid 250 passes through the first fluid passage 184 which narrows considerably in the direction of the outlet 186 to define a working nozzle. As a result of this narrow gap at the outlet 186, the liquid ejects out of the outlet 186 as a thin annulus of liquid. The initial path of the first fluid 250 from the outlet 186 of the first fluid passage 184 is substantially parallel to an inner surface 270 of the lip 189 formed by the cover 181.

According to various embodiments, different comparative amounts of the gaseous fluid agent and the liquid fluid agent may ultimately form the discharge for the suppressant 180. For example, in some embodiments, the nozzle 88 is configured such that the amount of the gaseous fluid agent in the suppressant 180 is comparatively larger than the amount of liquid fluid agent. Advantageously, such arrangements may increase the inerting effect of the suppressant 180 when applied to a thermal runaway event. Such arrangements may be achieved through variations of the particular dimensions and geometries of the nozzle 88 depicted herein. For example, the dimensions regarding the first fluid passage 184 and/or the outlet 260 may be reduced to decrease the amount of the liquid fluid agent in the suppressant 180. In other embodiments, the amount of the gaseous fluid agent and the liquid fluid agent are substantially equal. In other embodiments still, the amount of liquid fluid agent is greater than the amount of gaseous fluid agent in the suppressant 180.

In some embodiments, the second fluid 260 is the gaseous fluid agent. In some embodiments, the gaseous fluid agent is nitrogen. In other embodiments, the gaseous fluid agent is another gas such as compressed air or helium, for example. Due to the reduction and subsequent increase in the cross sectional area of the second fluid passage 185 (suggested above in regards to FIG. 5), the second fluid 260 is accelerated to a high velocity as it exits the outlet 203. The angle of the second fluid passage 185 is such that the accelerated second fluid 260 exits the outlet 203 and interacts with the thin annulus of liquid formed by the first fluid 250 issuing from the outlet 186 in a converging passageway 265. Accordingly, the accelerated second fluid 260 acts to entrain the first fluid 250 to form a mist discharge of small droplet size. Moreover, the inner surface 270 of the lip 189 ensures that larger droplets torn from the first fluid 250 that could be projected away from the longitudinal axis L of the apparatus by convergence with the second fluid 260 are prevented from doing so to provide for mixing of the first fluid 250 and the second fluid 260 in the converging passageway 265. Accordingly, the second fluid 260 entrains the first fluid 250 out of an outlet 280 of the converging passageway 265 and along a path 275 formed concentrically around the longitudinal axis L.

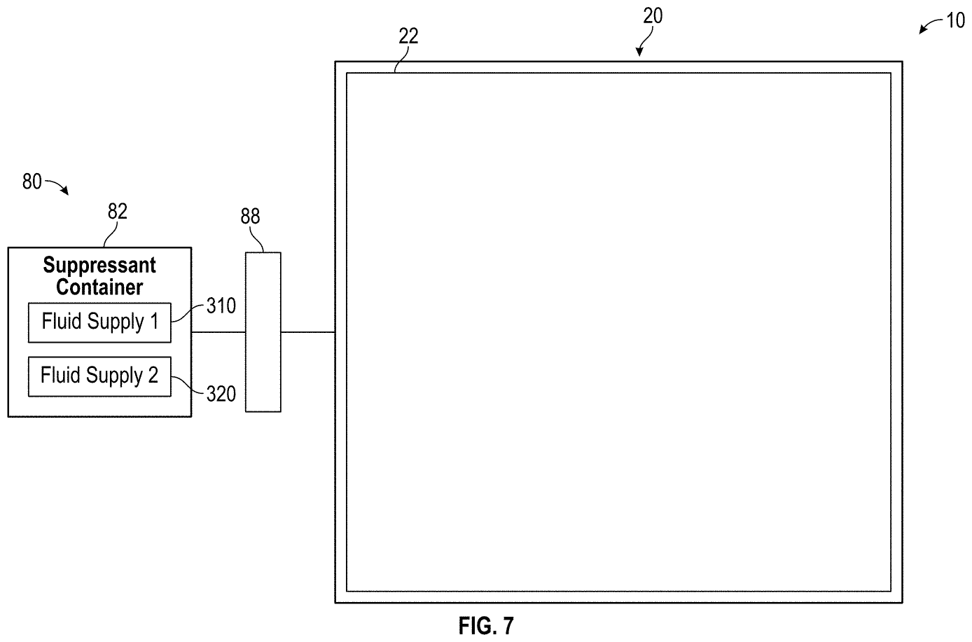

Referring to FIGS. 7-10, the mist discharge (e.g., suppression fluid) of the nozzle 88 is shown, according to various embodiments. As discussed above, the discharge of the nozzle 88 may produce a liquid fluid agent (e.g., water) discharge to be entrained by a high-velocity gaseous fluid agent. In some embodiments, the gaseous fluid agent is nitrogen. In other embodiments, the gaseous fluid agent is compressed air. In other embodiments still, the gaseous fluid agent is helium. It should be appreciated by one skilled in the art that the gaseous fluid agent may be any inert gas that may be appropriately used to entrain a cooling fluid such as water and suppress a thermal runaway event. In some embodiments, the small droplet size of the discharge of the nozzle 88 allows the discharge to penetrate areas of interest for fire suppression that are confined and/or partially inaccessible from direct agent application. As discussed in greater detail below, such areas of interest may include various passages, corners, and surfaces formed by the various batteries and housings of the battery pack 20. The discharge of the nozzle 88 may, therefore, be rapidly applied over a large area to suppress multiple hazard types (including battery assembly fires) in areas inaccessible to various other methods of direct application of hazard suppression fluids.

In some embodiments, the discharge of the nozzle 88 may operate to provide a multi-stage response to prevent, eliminate, and/or mitigate a failure or thermal runaway event. For example, the discharge of the nozzle 88 may apply the liquid fluid agent and gaseous fluid agent simultaneously to a hazard space. In some embodiments, the hazard space is a battery pack, such as the battery pack 20. Upon application, the gaseous fluid agent may inert the space to suppress the thermal runaway event. However, the gaseous fluid agent may disperse and/or leak out of the hazard space (e.g., through the pack housing 22) over time. The liquid fluid agent, discharged as a mist and entrained by the gaseous fluid agent to reach the various points of the hazard space, may remain in the hazard space to provide continued cooling and suppression of fire in the hazard space. Accordingly, the discharge of the nozzle 88 may be implemented to suppress hazards by providing rapid extinguishment (via the gaseous fluid agent and/or the liquid fluid agent) followed by extended suppression (via the liquid fluid agent). Further, the liquid fluid agent may be vaporized by heat generated by the thermal runaway event, thus allowing the liquid fluid agent to remain in the hazard space for an additional period of time. As suggested above, the amount of gaseous fluid agent discharged by the nozzle 88 may be comparatively equal to or larger than the amount of liquid fluid agent discharged by the nozzle 88, advantageously providing greater inerting of the hazard space.

In some embodiments, and as described in the various embodiments below, the battery pack 20 may form various arrangements of passages among the various batteries and housings included therein. The nozzle 88 may provide the discharge to the batteries and housings, as well as the various passages and surfaces formed by the various arrangements of batteries within the battery pack 20.

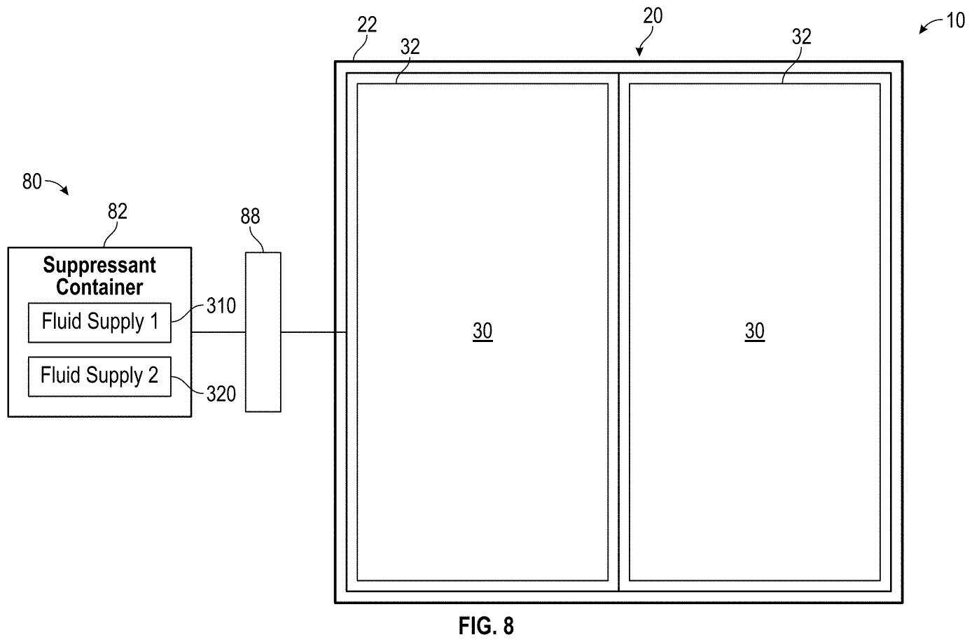

Referring to FIG. 7, the operation of the fire suppression system 80 in the system 10 is shown in relation to the battery pack 20, according to some embodiments. In addition to the components shown, the system 10 may include any of the other components included in the depiction of the system 10 as described above in regards to FIG. 1. The suppressant container 82 of the fire suppression system 80 includes a first fluid supply 310 and a second fluid supply 320. In some embodiments, the first fluid supply 310 contains the gaseous fluid agent and the second fluid supply 320 contains the liquid fluid agent. The first fluid supply 310 and the second fluid supply 320 provide the gaseous fluid agent the liquid fluid agent to the nozzle 88. The nozzle 88, as described above in regards to FIGS. 5 and 6, discharges a mist that operates to entrain the liquid fluid agent in the gaseous fluid agent. In other embodiments, the fire suppression system 80 includes addition suppressant containers and/or additional nozzles positioned in various arrangements to perform the various functions of fire suppression described herein. As shown, the discharge may be applied to the pack housing 22 of the battery pack 20 to suppress a thermal runaway event on the outside (e.g., surrounding, penetrating, and/or emerging from) the battery pack 20. As described in FIGS. 8-10 below, however, the discharge of the nozzle 88 may be also be applied extensively to the interior of the battery pack 20 to suppress thermal runaway events.

Referring to FIG. 8, the operation of the fire suppression system 80 in the system 10 is shown in relation to the subpacks 30 of the battery pack 20, according to some embodiments. In addition to the components shown, the system 10 may include any of the other components included in the depiction of the system 10 as described above in regards to FIGS. 1 and 7. As shown, the discharge of the nozzle 88 may enter the pack housing 22 of the battery pack 20 to reach the subpacks 30. The discharge may interact with the housings 32 of the subpacks 30 and the regions between the subpacks 30 (with respect to one another) and the regions between the subpacks 30 and the interior of the pack housing 22.

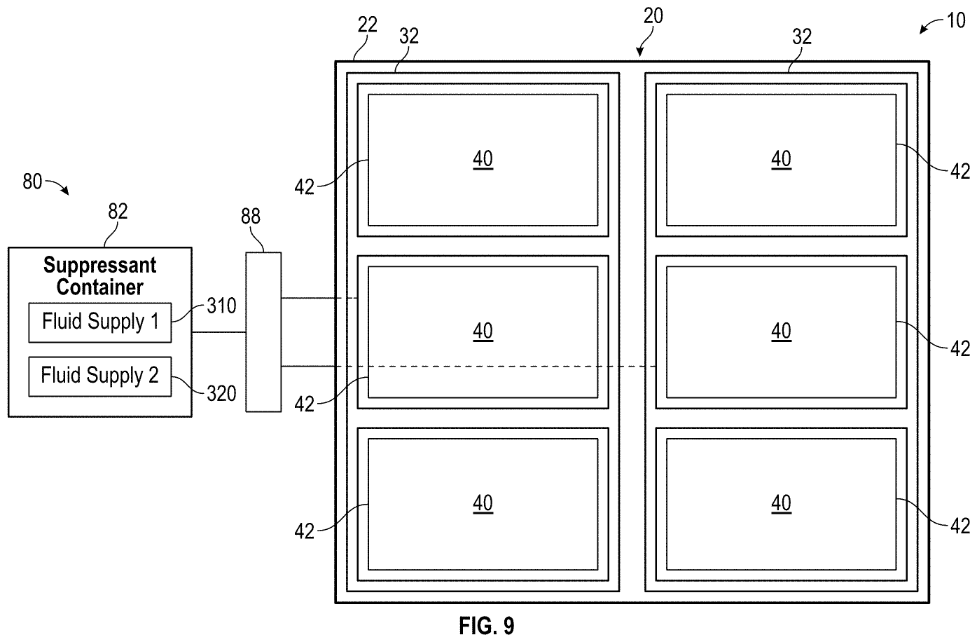

Referring to FIG. 9, the operation of the fire suppression system 80 in the system 10 is shown in relation to the modules 40, according to some embodiments. In addition to the components shown, the system 10 may include any of the other components included in the depiction of the system 10 as described above in regards to FIGS. 1, 7, and 8. As shown, the discharge of the nozzle 88 may enter the battery pack housing 22 of the battery pack 20 and the housings 32 of the subpacks 30 to reach the modules 40. The discharge may interact with the housings 42 of the module 40, the regions in between the modules 40 (with respect to one another), and the regions in between the modules 40 and the interior of the housings 32.

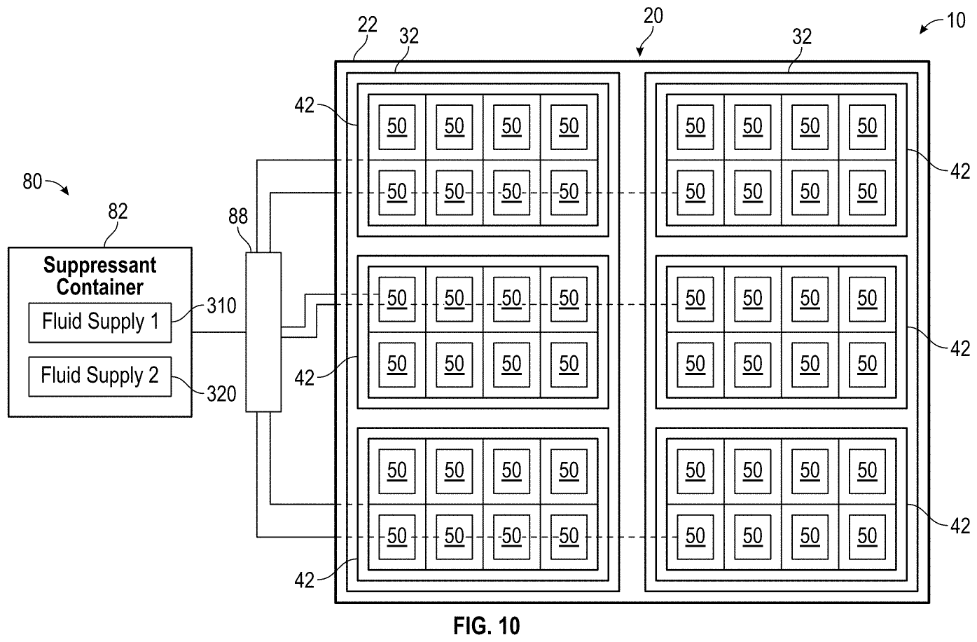

Referring to FIG. 10, the operation of the fire suppression system 80 in the system 10 is shown in relation to the battery cells 50, according to some embodiments. In addition to the components shown, the system 10 may include any of the other components included in the depiction(s) of the system 10 as described above in regards to FIGS. 1 and 7-9. As shown, the discharge of the nozzle 88 may enter the battery pack housing 22 of the battery pack 20, the housings 32 of the subpacks 30, and the housings 42 to reach the battery cells 50. The discharge may interact with the battery cells 50, the regions in between the battery cells 50 (with respect to one another), and the regions in between the battery cells 50 and the interior of the housings 42.

Configuration of the Exemplary Embodiments

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 as shown in the various exemplary embodiments is illustrative only. Additionally, any element disclosed in one embodiment may be incorporated or utilized with any other embodiment disclosed herein. For example, the arrangement of multiple battery packs 20 of the exemplary embodiment shown in at least FIG. 4 may be incorporated in the vehicle 130 of the exemplary embodiment shown in at least FIG. 3. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A fire suppression system for mitigating a thermal runaway event, the system comprising:
a battery pack having a housing defining a volume, a battery module arranged within the housing, and a plurality of battery cells arranged within the battery module, wherein the plurality of battery cells are configured to provide an electrical output; and
a suppression system coupled with the battery pack, the suppression system comprising a nozzle configured to receive a gaseous fluid and a liquid fluid, wherein the nozzle is configured to deliver a mist suppressant including the gaseous fluid and the liquid fluid to the battery pack, such that the gaseous fluid entrains the liquid fluid to mitigate the thermal runaway event.

2. The fire suppression system of claim 1, wherein the gaseous fluid is nitrogen.

3. The fire suppression system of claim 1, wherein the liquid fluid is water.

4. The fire suppression system of claim 1, wherein the mist suppressant is delivered to the battery pack such that the liquid fluid mitigates the thermal runaway event for a longer period of time than the gaseous fluid.

5. The fire suppression system of claim 1, wherein the mist suppressant is delivered to the battery pack such that the gaseous fluid inerts the volume within the housing to mitigate the thermal runaway event.

6. The fire suppression system of claim 1, wherein the nozzle is a venturi nozzle.

7. The fire suppression system of claim 1, wherein the plurality of battery cells arranged within the battery module define a plurality of passages arranged adjacent to the plurality of battery cells, and wherein the mist suppressant is delivered to the battery pack such that the mist suppressant is provided to the plurality of passages.

8. The fire suppression system of claim 1, wherein the battery module is a first battery module of a plurality of battery modules arranged within the housing, wherein the plurality of battery modules are arranged within the housing to define a plurality of passages arranged adjacent to the plurality of battery modules, and wherein the mist suppressant is delivered to the battery pack via the plurality of passages.

9. The fire suppression system of claim 1, wherein the mist suppressant is delivered to an exterior surface of the housing of the battery pack.

10. The fire suppression system of claim 1, wherein the gaseous fluid is carbon dioxide.

11. The fire suppression system of claim 1, wherein the gaseous fluid is argon.

12. The fire suppression system of claim 1, wherein a concentration of the gaseous fluid relative to a total volume of the mist suppressant is greater than a concentration of the liquid fluid relative to the total volume of the mist suppressant.

13. The fire suppression system of claim 1, wherein an amount of the gaseous fluid in the mist suppressant is greater than an amount of liquid fluid in the mist suppressant.

14. The fire suppression system of claim 1, wherein the mist suppressant is delivered to the battery pack such that the liquid fluid is vaporized by heat generated by the battery pack, wherein the vaporized fluid liquid inerts the volume of the housing to mitigate the thermal runaway event.

15. A method of mitigating a thermal runaway event within a battery pack, the method comprising:
receiving, at a first inlet of a nozzle, a gaseous fluid;
receiving, at a second inlet of the nozzle, a liquid fluid;
generating a mist suppressant, the mist suppressant comprising the gaseous fluid and the liquid fluid, such that the gaseous fluid entrains the liquid fluid; and
delivering, via an outlet of the nozzle, the mist suppressant to the battery pack to mitigate the thermal runaway event.

16. The method of claim 15, wherein receiving the gaseous fluid includes receiving nitrogen.

17. The method of claim 15, wherein receiving the liquid fluid includes receiving water.

18. The method of claim 15, wherein generating the mist suppressant includes generating the mist suppressant such that an amount of the gaseous fluid in the mist suppressant is greater than an amount of liquid fluid in the mist suppressant.

19. The method of claim 15, wherein delivering the mist suppressant to the battery pack includes delivering the mist suppressant to the battery pack such that the gaseous fluid inerts a volume within the battery pack to mitigate the thermal runaway event, and the liquid fluid mitigates the thermal runaway event for a longer period of time than the gaseous fluid.

20. A container system for mitigating a thermal runaway event, the container system comprising:
a container defining an inner volume;
a battery pack arranged within the container, the battery pack comprising:
a housing defining a volume;
a battery module arranged within the housing;
and a plurality of battery cells arranged within the battery module,
wherein the plurality of battery cells are configured to provide an electrical output; and
a suppression system coupled with the container, the suppression system comprising a nozzle configured to receive a gaseous fluid and a liquid fluid, wherein the nozzle is configured to deliver a mist suppressant including the gaseous fluid and the liquid fluid to the container, such that the gaseous fluid entrains the liquid fluid to mitigate the thermal runaway event.
